(19) United States
(12) Patent Application Publication
(10) Pub. No.: US 2026/0221370 A1
(43) Pub. Date: Jul. 30, 2026

(54) ENAMEL COATED FUSIBLE ELEMENT

(71) Applicant: Littelfuse, Inc., Rosemont, IL (US)

(72) Inventors: Marko Arciaga, Batangas (PH); Mark Joseph Ilagan Lian, Batangas (PH); Keon Mayson Brosas, Laguna (PH)

(73) Assignee: Littelfuse, Inc., Rosemont, IL (US)

(21) Appl. No.: 19/041,000

(22) Filed: Jan. 30, 2025

(51) Int. Cl. H01H 85/17; H01B 1/02; H01B 3/30; H01B 3/42; H01H 85/06

(52) U.S. Cl. CPC H01H 85/17; H01B 1/02; H01B 3/302; H01B 3/306; H01B 3/421; H01H 85/06

(57) ABSTRACT

A fuse wire including an electrically conductive core, a tin coating surrounding the electrically conductive core, and an enamel coating surrounding the tin coating. The enamel coating may be formed of one of polyesterimide, polyurethane, and polyester and may have a cut-through temperature in a range of 265 degrees Celsius to 350 degrees Celsius.

### FIELD OF THE DISCLOSURE

The present disclosure relates generally to the field of circuit protection devices and relates more particularly to a fusible element adapted to mitigate solder ball and beading defects.

### FIELD OF THE DISCLOSURE

Cartridge fuses are widely used in electrical systems to provide overcurrent protection. A typical cartridge fuse includes an electrically insulating, hollow fuse body, a fuse wire extending through the fuse body, and electrically conductive endcaps disposed on opposing ends of the fuse body. The fusible wire is electrically connected to the endcaps, often using solder domes located on interior surfaces of the endcaps. During installation of the fuse within a circuit, the endcaps may be electrically connected to corresponding contacts on a circuit board, such as with solder.

For high I²t applications, a fuse is commonly provided with a fuse wire formed of a copper wire with a tin coating. A shortcoming associated with such a fuse wire is that, when the fuse wire is soldered to the endcaps of a fuse during assembly, heat from the soldering process can cause the tin coating of the fuse wire to reflow and migrate to the solder domes on the interior surfaces of the endcaps. Such reflow and migration of the tin coating can also occur during installation of the fuse, caused by heat generated when the fuse is soldered to a circuit board. In either case, the reflow and migration of the tin coating can result in tin solder ball defects and tin beading defects, which can detrimentally affect the reliability of the fuse.

It is with respect to these and other considerations that the present improvements may be useful.

### SUMMARY

This Summary is provided to introduce a selection of concepts in a simplified form that are further described below in the Detailed Description. This Summary is not intended to identify key features or essential features of the claimed subject matter, nor is it intended as an aid in determining the scope of the claimed subject matter.

A fuse wire in accordance with an embodiment of the present disclosure may include an electrically conductive core, a tin coating surrounding the electrically conductive core, and an enamel coating surrounding the tin coating.

A fuse in accordance with an embodiment of the present disclosure may include a tubular fuse body, a first endcap disposed on a first longitudinal end of the fuse body, a second endcap disposed on a second longitudinal end of the fuse body, an electrically insulating core extending longitudinally through a hollow interior of the fuse body, and a fuse wire wrapped around the electrically insulating core and electrically connected to the first and second endcaps by respective first and second solder domes, wherein the fuse wire includes an electrically conductive core, a tin coating surrounding the electrically conductive core, and an enamel coating surrounding the tin coating.

### BRIEF DESCRIPTION OF THE DRAWINGS

FIG. 1 is a perspective view illustrating a fuse wire in accordance with an embodiment of the present disclosure; and

FIG. 2 is a cross-sectional view illustrating a fuse in accordance with an embodiment of the present disclosure.

The drawings are not necessarily to scale. The drawings are merely representations, not intended to portray specific parameters of the disclosure. The drawings are intended to depict exemplary embodiments of the disclosure, and thus are not to be considered as limiting in scope. In the drawings, like numbering represents like elements.

### DETAILED DESCRIPTION

Embodiments of a fuse wire and a fuse in accordance with the present disclosure will now be described more fully with reference to the accompanying drawings, in which preferred embodiments of the present disclosure are presented. The fuse wire and the fuse of the present disclosure may, however, be embodied in many different forms and should not be construed as being limited to the embodiments set forth herein. Rather, these embodiments are provided so that this disclosure will be thorough and complete, and will fully convey the scope of the fuse wire and the fuse to those skilled in the art. In the drawings, like numbers refer to like elements throughout unless otherwise noted.

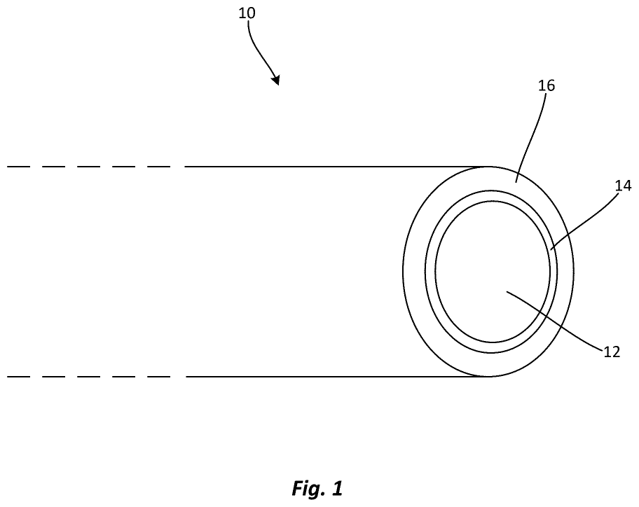

Referring to FIG. 1, a perspective view illustrating a length/segment of a fuse wire 10 in accordance with the present disclosure is shown. The fuse wire 10 may include a core 12, which serves as a primary conductive pathway in the fuse wire 10. The core 12 may be formed of copper or any other suitably conductive metal (e.g., silver, gold, etc.). In various embodiments, the core 12 may have a diameter in a range of 0.010 millimeters to 0.500 millimeters. The present disclosure is not limited in this regard.

The fuse wire 10 may further include a tin coating 14 surrounding the core 12. In various embodiments, the tin coating 14 may be applied to the core 12 via electroplating or other suitable processes and may have a thickness in a range of 0.001 millimeters to 0.050 millimeters. The present disclosure is not limited in this regard. The tin coating 14 may facilitate soldering of the fuse wire 10 to establish robust electrical connections when the fuse wire 10 is installed within a fuse (e.g., when the fusible element 10 is soldered to endcaps of a fuse as further described below).

The fuse wire 10 may further include an enamel coating 16 surrounding the tin coating 14. In various embodiments, the enamel coating 16 may be formed of polyesterimide, polyurethane, or polyester and may be applied to the tin coating 14 via dip-coating or other suitable processes. In various embodiments, the enamel coating 16 may have a thickness in a range of 0.001 millimeters to 0.050 millimeters. The present disclosure is not limited in this regard.

The enamel coating 16 may be adapted to dissolve upon contact with molten solder to allow the underlying tin coating 14 and core 12 to be soldered to endcaps of a fuse to form electrical connections therewith. Additionally, the enamel coating 16 may act as a heat-resistant barrier that protects the underlying tin coating 14 to prevent excessive reflow and migration of the tin coating 14 that could otherwise result from heat generated when the fuse wire 10 is installed within a fuse (e.g., when the fuse wire 10 is soldered to endcaps of a fuse) and/or from heat generated when the fuse is soldered to contacts on a circuit board. In various embodiments, the enamel coating 16 may have a cut-through temperature in a range of 265 degrees Celsius to 350 degrees Celsius. The present disclosure is not limited in this regard. By mitigating reflow and migration of the tin coating 14, the enamel coating 16 may prevent or significantly mitigate tin solder ball defects and tin beading defects that could otherwise detrimentally affect the reliability of a fuse.

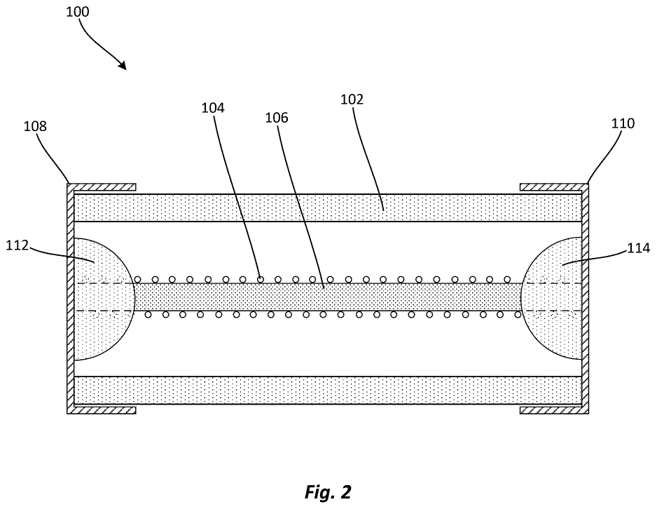

Referring to FIG. 2, a cross-sectional view of a cartridge fuse 100 (hereinafter “the fuse 100”) in accordance with an exemplary embodiment of the present disclosure is shown. The fuse 100 may include an elongated, tubular fuse body 102 formed of an electrically insulating and preferably heat-resistant material. Such materials may include, but are not limited to, ceramic and glass. The fuse body 102 may have the shape of a rectangular tube, but this is not critical. Alternative embodiments of the fuse 100 may have a fuse body 102 with the shape of an oval tube, a triangular tube, etc.

The fuse 100 may further include a fuse wire 104 that is substantially identical to the fuse wire 10 described above. Namely, the fuse wire 104 may include an electrically conductive core, a tin coating surrounding the core, and an enamel coating surrounding the tin coating as described above with reference to the fuse wire 10. In various embodiments, the fuse wire 104 may be wound or wrapped around a core 106 formed of an electrically insulating material (e.g., fiberglass) that extends longitudinally through a hollow interior of the fuse body 102. The fuse wire 104 may be mechanically and electrically connected to interior surfaces of first and second endcaps 108, 110 disposed on the opposing longitudinal ends of the fuse body 102 by respective first and second solder domes 112, 114. The first and second endcaps 108, 110 may be formed of an electrically conductive material, including, but not limited to, copper or one of its alloys, and may be plated with nickel or other conductive, corrosion resistant coatings. Thus, the first and second endcaps 108, 110 may facilitate electrical connection of the fuse 100 within a circuit. For example, the first and second endcaps 108, 110 can be soldered to respective terminals on a printed circuit board (not shown).

During assembly of the fuse 100, and as described above, the enamel coating on the fuse wire 104 may be adapted to dissolve upon contact with molten solder (i.e., upon contact with the first and second solder domes 112, 114 when they are in a molten state) to allow the underlying tin coating and core of the fuse wire 104 to be soldered to the first and second endcaps 108, 110 to form reliable electrical connections therewith. Additionally, the enamel coating may act as a heat-resistant barrier that prevents excessive reflow and migration of the underlying tin coating to the first and second solder domes 112, 114 that could otherwise result from heat generated when the fuse wire 104 is installed within the fuse 100 (e.g., when the fuse wire 10 is soldered to the first and second endcaps 108, 110), and/or from heat generated when the first and second endcaps 108, 110 are soldered to contacts on a circuit board. By mitigating reflow and migration of the tin coating, the enamel coating may prevent or significantly mitigate tin solder ball defects and tin beading defects that could otherwise detrimentally affect the reliability of the fuse 100.

As used herein, an element or step recited in the singular and proceeded with the word “a” or “an” should be understood as not excluding plural elements or steps, unless such exclusion is explicitly recited. Furthermore, references to “one embodiment” of the present disclosure are not intended to be interpreted as excluding the existence of additional embodiments that also incorporate the recited features.

While the present disclosure makes reference to certain embodiments, numerous modifications, alterations and changes to the described embodiments are possible without departing from the sphere and scope of the present disclosure, as defined in the appended claim(s). Accordingly, it is intended that the present disclosure not be limited to the described embodiments, but that it has the full scope defined by the language of the following claims, and equivalents thereof.

1. A fuse wire comprising:
an electrically conductive core;
a tin coating surrounding the electrically conductive core; and
an enamel coating surrounding the tin coating.

2. The fuse wire of claim 1, wherein the electrically conductive core is formed of one of copper, silver, and gold.

3. The fuse wire of claim 1, wherein the electrically conductive core has a diameter in a range of 0.010 millimeters to 0.500 millimeters.

4. The fuse wire of claim 1, wherein the tin coating has thickness in a range of 0.001 millimeters to 0.050 millimeters.

5. The fuse wire of claim 1, wherein the enamel coating has thickness in a range of 0.001 millimeters to 0.050 millimeters.

6. The fuse wire of claim 1, wherein the enamel coating is formed of one of polyesterimide, polyurethane, and polyester.

7. The fuse wire of claim 1, wherein the enamel coating has a cut-through temperature in a range of 265 degrees Celsius to 350 degrees Celsius.

8. A fuse comprising:
a tubular fuse body;
a first endcap disposed on a first longitudinal end of the fuse body;
a second endcap disposed on a second longitudinal end of the fuse body;
an electrically insulating core extending longitudinally through a hollow interior of the fuse body; and
a fuse wire wrapped around the electrically insulating core and electrically connected to the first and second endcaps by respective first and second solder domes, the fuse wire comprising:
an electrically conductive core;
a tin coating surrounding the electrically conductive core; and
an enamel coating surrounding the tin coating.

9. The fuse of claim 8, wherein the electrically conductive core is formed of one of copper, silver, and gold.

10. The fuse of claim 8, wherein the electrically conductive core has a diameter in a range of 0.010 millimeters to 0.500 millimeters.

11. The fuse of claim 8, wherein the tin coating has thickness in a range of 0.001 millimeters to 0.050 millimeters.

12. The fuse of claim 8, wherein the enamel coating has thickness in a range of 0.001 millimeters to 0.050 millimeters.

13. The fuse of claim 8, wherein the enamel coating is formed of one of polyesterimide, polyurethane, and polyester.

14. The fuse of claim 8, wherein the enamel coating has a cut-through temperature in a range of 265 degrees Celsius to 350 degrees Celsius.
